(19) United States
(12) Patent Application Publication
(10) Pub. No.: US 2014/0156535 A1
(43) Pub. Date: Jun. 5, 2014

(54) SYSTEM AND METHOD FOR REQUESTING AND PROCESSING PIN DATA USING A DIGIT SUBSET FOR SUBSEQUENT PIN AUTHENTICATION

(71) Applicants: Nameh Jabbour, Mississauga (CA); Sinan Olcayto Akdeniz, Mississauga (CA)

(72) Inventors: Nameh Jabbour, Mississauga (CA); Sinan Olcayto Akdeniz, Mississauga (CA)

(21) Appl. No.: 13/906,646

(22) Filed: May 31, 2013

Related U.S. Application Data
(60) Provisional application No. 61/654,420, filed on Jun. 1, 2012.

(51) Int. Cl. G06Q 20/40; G06Q 20/38; G06K 5/00

(52) U.S. Cl. CPC G06Q 20/4012; G06K 5/00; G06Q 20/3821
USPC 705/72; 235/380

(57) ABSTRACT

A system and method for authenticating a personal identification number (PIN) associated with a payment card of a cardholder, the PIN being a code having a sequence of digits, the method comprising the steps of: presenting a PIN entry request including identifying a digit subset of the code, such that the digits in the digit subset is at least one digit less than the digits of the code; receiving the digit subset in response to the PIN entry request; sending an authentication request based on the digit subset; receiving an authentication response including response data; and presenting a response to the cardholder based on the response data, the response including information representative of whether the PIN was successfully authenticated or not using the digit subset.

### CROSS REFERENCE TO RELATED APPLICATIONS

This application is a non provisional application of U.S. application Ser. No. 61/654,420, filed Jun. 1, 2012, the contents of which are incorporated herein by reference.

### FIELD

The present invention is related to collection and confirmation of PIN data of a payment card.

### BACKGROUND

Until the introduction of Chip and PIN, all face-to-face credit or debit card transactions used a magnetic stripe or mechanical imprint to read and record account data, and a signature for verification. Under this system, the customer handed their card to the clerk at the point of sale, who either “swiped” the card through a magnetic reader or made an imprint from the raised text of the card. In the former case, the account details were verified and a slip for the customer to sign was printed. In the case of a mechanical imprint, the transaction details were filled in and the customer signed the imprinted slip. In either case, the clerk verified that the signature matches that on the back of the card to authenticate the transaction.

The magnetic of mechanical imprint systems proved reasonably effective, but had a number of security flaws, including the ability to steal a card in the post, or to learn to forge the signature on the card. More recently, technology has become available on the black market for both reading and writing the magnetic stripes, allowing cards to be easily cloned and used without the owner's knowledge.

For transactions using PIN enabled cards, where the customer and their card are with them at the point of sale, a further disadvantage with this is that the customer must use the keypad of the merchant terminal to enter in their PIN information. Fraudulent incidences are on the rise where PIN information has been stolen through the use of fraudulent merchant terminals designed for this purpose. Accordingly, cardholders are currently experiencing a decreased sense of payment security, especially in those situations where the merchant is considered by the cardholder as possibly suspect such as in foreign countries or for stores or locations in which the cardholder is unfamiliar.

Further, incidents of fraud by man-in-the-middle attacks are on the rise, where criminals have attached fake keypads or card readers to existing machines. These have then been used to record customers' PINs and bank card information in order to gain unauthorized access to their accounts. Various ATM manufacturers have put in place countermeasures to protect the equipment they manufacture from these threats, however the disadvantage of the countermeasures to date is that they rely upon complex technological solutions which always have the possibility of circumvention by the criminals in order to obtain the complete PIN information still available.

Alternate methods to verify cardholder identities have been tested and deployed in some countries, such as finger and palm vein patterns, iris, and facial recognition technologies, however these solutions are not as convenient to cardholders as the simple combination digit PINs adopted currently. It is also recognised that cheaper mass produced equipment has been developed and is being installed in machines globally that detect the presence of foreign objects on the front of ATMs, however this solution does not address those circumstances where the card reader terminal is itself the fraudulent device.

It is also recognised that fraudulent activity associated with payment cards is not only related to local petty crime resulting in financial losses incurred directly by merchants and cardholders but more importantly is becoming increasingly associated with organized crime, such that substantial sums of money are being siphoned out of the profits of the financial institutions themselves and distributed worldwide. In many instances, it has been shown that the fraudulent activity has been used to fund terrorist activities.

### SUMMARY

Presently there is a need for a system and method to facilitate card holder present transactions between entities using a PIN request and authentication process that addresses at least one of the identified problems in the current state of the art.

Incidents of fraud by man-in-the-middle attacks are on the rise, where criminals have attached fake keypads or card readers to existing machines. These have then been used to record customers' PINs and bank card information in order to gain unauthorized access to their accounts. Various ATM manufacturers have put in place countermeasures to protect the equipment they manufacture from these threats, however the disadvantage of the countermeasures to date is that they rely upon complex technological solutions which always have the possibility of circumvention by the criminals in order to obtain the complete PIN information still available. Contrary to current fraud prevention systems there is provided a system and method for authenticating a personal identification number (PIN) associated with a payment card of a cardholder, the PIN being a code having a sequence of digits, the method comprising the steps of: presenting a PIN entry request including identifying a digit subset of the code, such that the digits in the digit subset is at least one digit less than the digits of the code; receiving the digit subset in response to the PIN entry request; sending an authentication request based on the digit subset; receiving an authentication response including response data; and presenting a response to the cardholder based on the response data, the response including information representative of whether the PIN was successfully authenticated or not using the digit subset.

A first aspect provided is a method for authenticating a personal identification number (PIN) associated with a payment card of a cardholder, the PIN being a code having a sequence of digits, the method comprising the steps of: presenting a PIN entry request including identifying a digit subset of the code, such that the digits in the digit subset is at least one digit less than the digits of the code; receiving the digit subset in response to the PIN entry request; sending an authentication request based on the digit subset; receiving an authentication response including response data; and presenting a response to the cardholder based on the response data, the response including information representative of whether the PIN was successfully authenticated or not using the digit subset.

A second aspect provided is a system for authenticating a personal identification number (PIN) associated with a payment card of a cardholder, the PIN being a code having a sequence of digits, the system comprising: a computer processor coupled to a physical memory, wherein the computer processor is programmed to coordinate the authenticating of the PIN by: presenting a PIN entry request to the cardholder including identifying a digit subset of the code, such that the digits in the digit subset is at least one digit less than the digits of the code; receiving the digit subset in response to the PIN entry request; sending an authentication request based on the digit subset; receiving an authentication response including response data; and presenting a response to the cardholder based on the response data, the response including information representative of whether the PIN was successfully authenticated or not using the digit subset.

A third aspect provided is a non-transitory computer readable storage medium with an executable program application stored thereon, the program application for authenticating a personal identification number (PIN) associated with a payment card of a cardholder, the PIN being a code having a sequence of digits, wherein the program application is configured to instruct a computer processor to perform the following steps of: presenting a PIN entry request to the cardholder including identifying a digit subset of the code, such that the digits in the digit subset is at least one digit more than the digits of the code; receiving the digit subset in response to the PIN entry request; sending an authentication request based on the digit subset; receiving an authentication response including response data; and presenting a response to the cardholder based on the response data, the response including information representative of whether the PIN was successfully authenticated or not using the digit subset.

### BRIEF DESCRIPTION OF THE DRAWINGS

Exemplary embodiments of the invention will now be described in conjunction with the following drawings, by way of example only, in which:

FIG. 1 is a block diagram of components of a payment card transaction system;

FIG. 2 is a block diagram of an example card reader terminal for implementing the payment application of FIG. 1;

FIG. 3 is a block diagram of an example computer device for implementing the processing system of FIG. 1; and

FIG. 4 is a flowchart for an example operation of the system of FIG. 1.

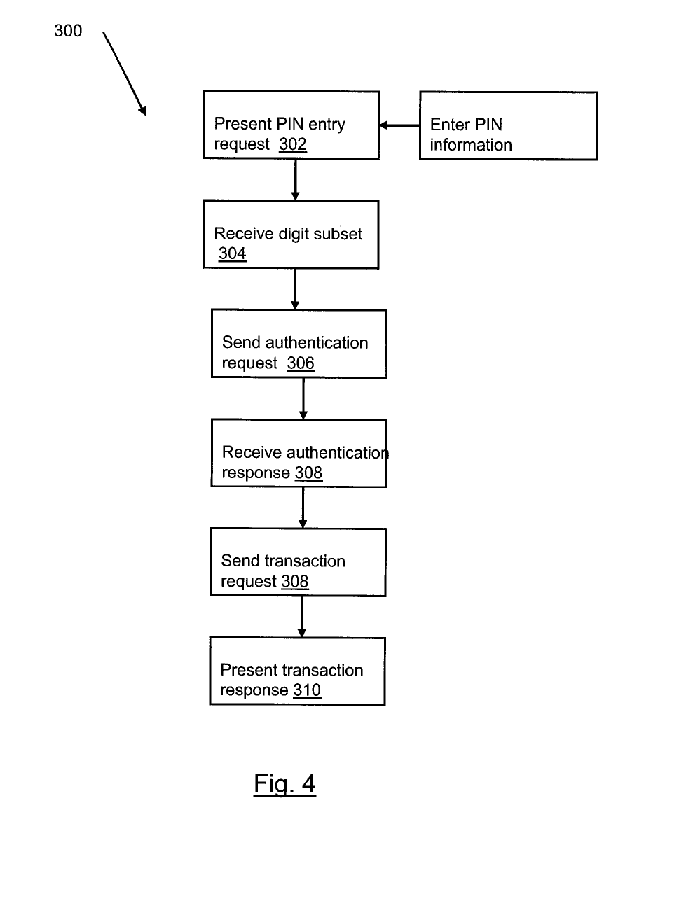

### DETAILED DESCRIPTION OF THE PREFERRED EMBODIMENT(S)

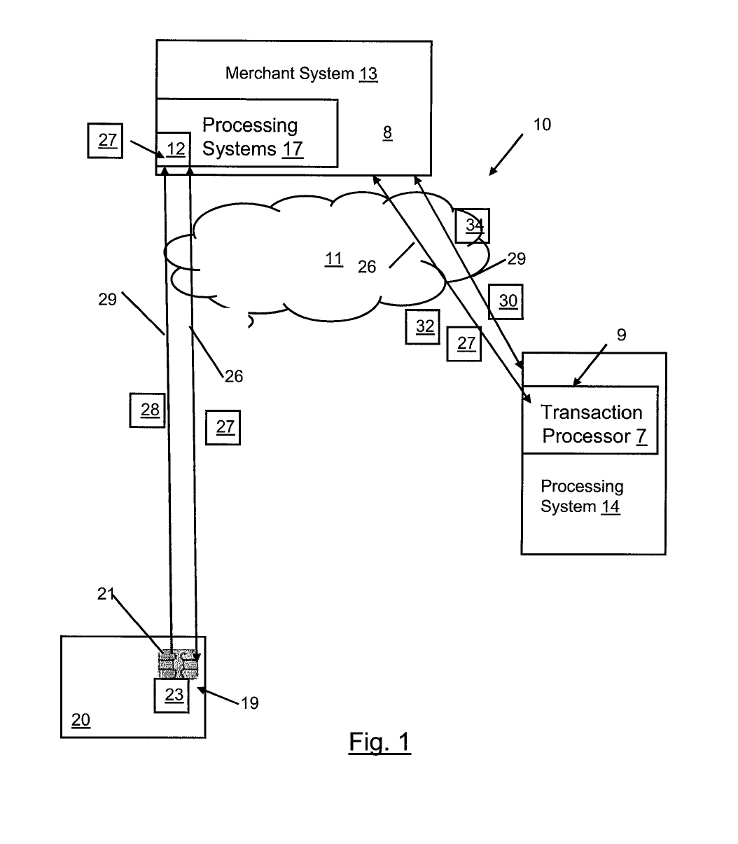

Referring to FIG. 1, shown is a payment card transaction system 10 that is configured to address skimming, which is the theft of credit card information used in an otherwise legitimate transaction. In skimming, the thief can procure a victim's credit card 20 number using basic methods such as photocopying receipts or more advanced methods such as using a small electronic device (skimmer) to swipe and store hundreds of victims' credit card numbers. Common scenarios for skimming are restaurants or bars where the skimmer has possession of the victim's credit card out of their immediate view. The thief may also use a small keypad to unobtrusively transcribe the 3 or 4 digit PIN or Card Security Code which is not present on the chip or magnetic strip 19 (e.g. a card storage medium 19). Skimming can also occur at merchants, such as gas stations when a third-party card-reading device is installed either out-side or inside a fuel dispenser or other card-swiping terminal 12. This third-party card-reading device allows a thief to capture a customer's credit and debit card information, including their PIN, with each card 20 swipe. Instances of skimming have been reported where the perpetrator has put a skimming device over the card slot of an ATM (automated teller machine) card reader terminal 12, which reads the chip or magnetic strip 19 as the user unknowingly passes their card 20 through it.

These skimming devices are often used in conjunction with a miniature camera (inconspicuously attached to the ATM) to read the user's PIN at the same time. Another skimming technique used is a keypad overlay that matches up with the buttons of the legitimate keypad of the card reader terminal 12 below it and presses them when operated, but records or transmits the key log of the PIN entered by wireless to a nearby computer system of the thief. The skimming device or group of devices illicitly installed on a legitimate card reader terminal 12 or are placed in substitution of a legitimate card reader terminal 12 are also colloquially known as a “skimmer”.

Referring again to FIG. 1, shown is the environment 10 having a merchant order and account processing system 13 (implemented by computer device 8) that can include a point of sale (POS) terminal (also sometimes referred to as Point of Purchase (POP), and a payment transaction processing system 14. It is recognised that the merchant system 13 could also be an automated teller machine or automatic teller machine (ATM), also known as an automated banking machine (ABM). In any event, the merchant system 13 includes a card reader terminal 12 for use in reading card data 23 stored in memory 19 of the payment card 20 during processing of a financial transaction 24 between the financial processing system 14 and a cardholder, once the cardholder has put the payment card in a card interface (e.g. magnetic stripe reader mechanism, chip reader mechanism or contactless reader mechanism) of the card reader terminal 12.

### Merchant System 13

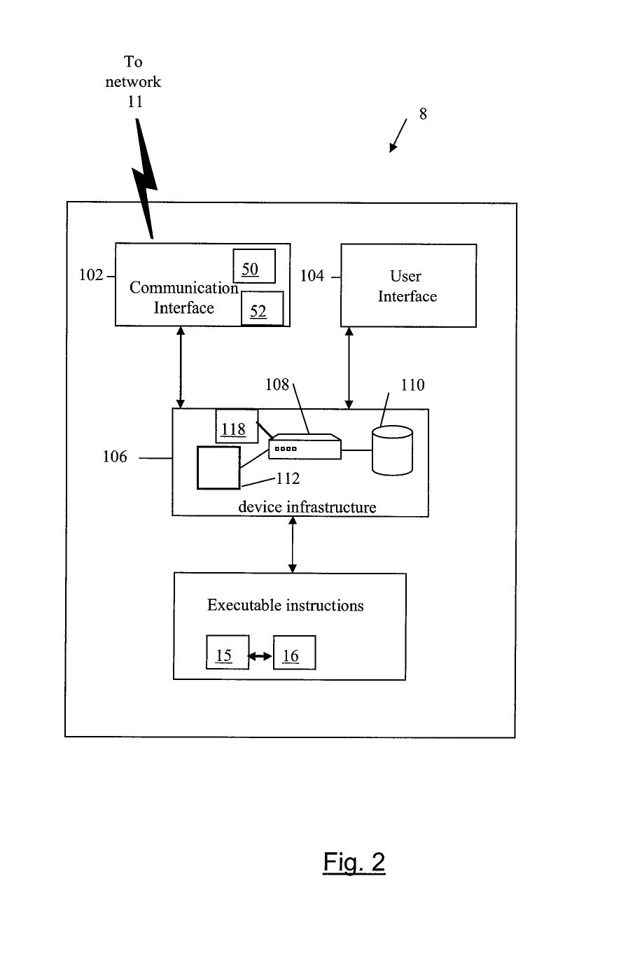

The merchant system 13 (e.g. bank providing an ATM, merchant providing a POS device, merchant providing a white label ATM, etc.) is the location where a financial transaction via messages can be initiated and confirmation of transaction acceptance or rejection is received, such that the merchant is the business (bricks and mortar and/or on-line store or service) taking payment from the cardholder for their products or services. One example of the goods and services is gas purchased from a gas station using a card reader terminal 12 provided by the gas station merchant 13. The transaction information (e.g. PIN) required from the cardholder of the payment card 20 is provided to the merchant system 13 using the user interface 104 of the card reader terminal 12 (see FIG. 2).

In the case of an ATM, the products or services are considered the initiation, processing and result of the financial transaction, such that the result can be the dispensing of cash, deposit of cash or checks, transfer of funds between financial accounts of the cardholder, payment of bills, or any other financial transaction result provided by the ATM. It is the automated teller machine (ATM) at which the transaction information (e.g. PIN) required from the cardholder of the payment card 20 is entered.

It should be recognized that the merchant system 13 can include a physical POS terminal (e.g. an electronic cash register) in close physical proximity to the cardholder at the time of purchase (i.e. providing a keypad or touch screen (or other data entry interface) for use by the cardholder of the card reader terminal 12 of the cardholder). Alternatively, the merchant system 13 can be embodied as an on-line merchant order service (e.g. a merchant order web site) that is accessed remotely by the cardholder over a communications network 11 using an appropriate network communication protocol 50 (e.g. wired and/or wireless), such that part of the transaction information (e.g. PIN) required from the cardholder of the payment card 20 is entered and provided to the merchant system 13 using the user interface of a computer device of the cardholder.

The card reader terminal 12 (see FIG. 2) can include any of the following example components: CPU 108 (to control the user interface and transaction devices); magnetic and/or chip card reader mechanism 118 to identify the cardholder by reading the card data 23); a PIN pad as part of the user interface 104 (e.g. similar in layout to a touch tone or calculator keypad), often manufactured as part of a secure enclosure; a secure cryptoprocessor (can be part of the CPU 108 or one of many CPUs 108) generally within the secure enclosure; a display that is also part of the user interface 104 that is used by the customer for performing the transaction; function key buttons (usually close to the display) or a touch screen used by the cardholder to select the various aspects of the transaction, which are considered part of the user interface 104; a record printer to provide the customer with a record of their transaction—not shown; in the case of an ATM a vault used to store the parts of the machinery requiring restricted access; and a housing for aesthetics and to attach signage to.

Also included is a payment application 16, executed by the computer infrastructure 106 of the card reader terminal 12. The payment application 16, as further described below, provides PIN entry instructions and PIN entry responses 15 presented (e.g. written instructions and responses displayed on the display of the user interface 104) to the cardholder that account for the way in which that PIN data is requested and accepted by the card reader device 12. It is recognised that the PIN entry instructions and PIN entry responses 15 provided to the user interface 104 by the payment application 16 may be obtained (i.e. stored instructions and responses 15) from the local device memory 110 and/or can be obtained from the processing system 14 over the communications network 11 as further described below.

The PIN entry instructions 15 can be embodied as a set of questions 15 available for presentment to the cardholder via the user interface 104 of the card reader terminal 12. The PIN entry instructions 15 can be stored as a set of predefined question 15 content (e.g. for a four digit PIN the stored questions 15 could be “Please enter your PIN subset by omitting the first digit”, “Please enter your PIN subset by omitting the second digit”, “Please enter your PIN subset by omitting the third digit” and “Please enter your PIN subset by omitting the fourth digit”). Preferably, by example, the payment application 16 could be configured to select one question 15 (e.g. randomly) from the set of questions 15 for subsequent presentment to the cardholder. Alternatively, the processing system 14 could instruct the card reader terminal 12 as to which question 15 from the set of questions 15 to present. Selection of which question 15 to present to the cardholder from the set of questions 15 can be implemented as a random selection.

It is recognised in the case of one digit omitted from a four digit PIN, there would be a set of four possible questions 15 due to the available combinations of omitting one of four possible digits positions in the digit sequence of the PIN code, along with the corresponding four possible digit subset responses 15 provided by the cardholder. In general terms, it is recognised in the case of X digits omitted from a Y digit PIN, such that Y is greater than X, there would be a set of possible questions 15 equal to the number result of Y distinct digits taken/omitted X at a time (e.g. omitting X of Y possible digit positions in the digit sequence of the PIN code, along with the corresponding possible digit subset responses 15 provided by the cardholder. Another example of this is for a six digit PIN, wherein the number of possible questions 15 with three digits missing would be 20, i.e. the number result of 6 distinct digits taken/omitted 3 at a time (e.g. omitting 3 of 6 possible digit positions in the digit sequence of the PIN code). Another example of this is for a six digit PIN, wherein the number of possible questions 15 with two digits missing would be 15, i.e. the number result of 6 distinct digits taken/omitted 2 at a time (e.g. omitting 2 of 6 possible digit positions in the digit sequence of the PIN code).

In view of the above, it is also recognised that similar sets of questions 15 could be constructed in the case where an extra digit or digits are added to the digit subset requested by the PIN entry instructions 15, as desired.

### Financial Processing System 14

Most card reader terminals 12 (e.g. ATMs) are connected to interbank networks, enabling people to withdraw and deposit money or provide payment to a merchant in exchange for purchased goods and services from machines not belonging to the bank where they have their accounts or in the countries where their accounts are held (enabling cash withdrawals in local currency). Some examples of interbank networks include NYCE, PULSE, PLUS, Cirrus, AFFN, Interac, Interswitch, STAR, LINK, MegaLink and BancNet.

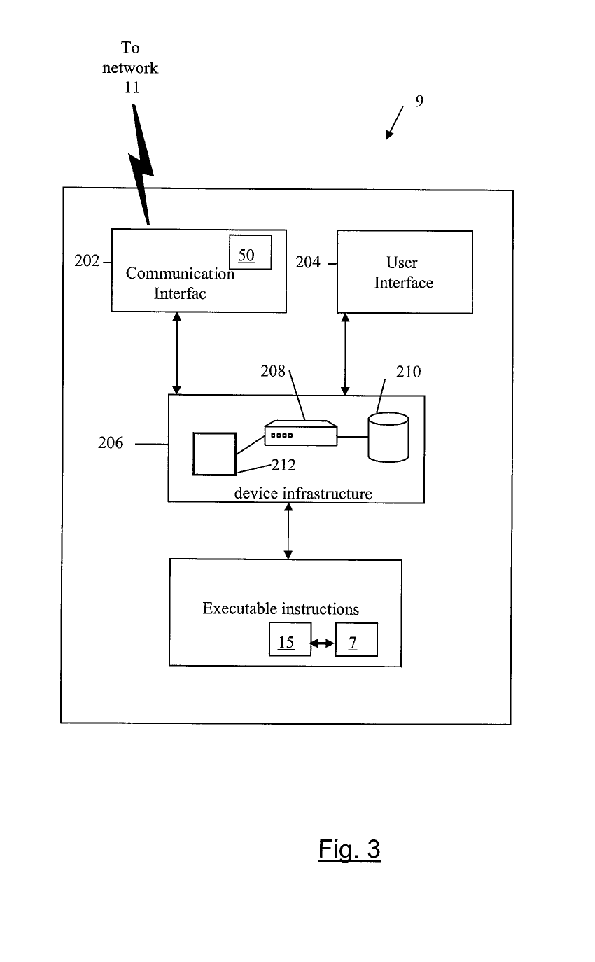

For online transactions, card reader terminals 12 could rely on authorization of a financial transaction by the card issuer or other authorizing institution (e.g. a transaction processor 7 of the processing system 14—as implemented via a computer device 9 of FIG. 3) via the communications network 11. This can be performed through an ISO 8583 messaging system. In terms of an ATM example of a card reader terminal 12, ATMs typically connect directly to their host or controller (e.g. part of the processing system 14) via either ADSL or dial-up modem over a telephone line or directly via a leased line, for example using a VPN (virtual private network) connection. Common lower-level layer communication protocols 50 used by ATMs (e.g. card reader terminals 12) to communicate with the transaction processor 7 of the processing system 14 can include SNA over SDLC, TC500 over Async, X.25, and TCP/IP over Ethernet. In addition to methods employed for transaction security and secrecy, all communications 50 traffic between the ATM (e.g. card reader terminals 12) and the transaction processor 7 may also be encrypted via methods such as SSL. It is recognised that the transaction processor 7 can be implemented as an algorithm (e.g. software as a series of computer implemented instructions) to compare the contents of the authentication request 26, e.g. digit subset 27, a numeric representation of the digit subset such as a calculated value (such as a PVV) based on a comparison of the digit subset with the actual code of the PIN, etc., to stored comparison data available to the transaction processor 7 (e.g. possible digit subsets, the code digits of the PIN, any calculated values such as a PVV, etc. It is also recognised that the transaction processor 7 can also be referred to as an authorization processor, for example where the functionality of the transaction processor 7 is limited to PIN authentication.

Settlement of the financial transaction by the transaction processor 7 can be defined as performing the settlement (e.g. debit of funds specified in the financial transaction from an account and crediting of the funds in to another account). Further, transaction settlement can be defined as where the funds amount is transferred from the one account to the other account, i.e. the credit and debit transactions of the funds amount against the respective accounts are either performed (e.g. in real time) or promised to be performed (e.g. included in a batch transaction to be performed later in the day or following business day), such that the accounts are of the cardholder (e.g. payment card 20 account) and the merchant (e.g. merchant back account) administered through financial institutions (not shown) associated with or otherwise implementing the payment processing system 14. It is also recognised that the settlement of the financial transaction by the transaction processor 7 can be defined as performing the settlement as debit/credit of funds specified in the financial transaction from the account of the cardholder in the case of ATM usage.

In view of the above, the merchant system 13 includes order and account processing systems 17 (e.g. a merchant order interface including a web service interface for interacting with the cardholder) that can include accounting systems for keeping records of financial transactions related to product orders, accounting systems for sending financial transactions directly to the payment transaction processing system 14 for settlement and receiving and processing settlement information related to the processing of the financial transaction, POS systems including user interfaces (e.g. keypads) for entry of data related to financial transactions by customers (e.g. the cardholder), and/or product ordering systems for generating bills of sale, order invoices, issuing of sales receipts (printed or electronic) and/or related accounts receivable systems.

It is recognised that the transaction processor 7 of the processing system 14 can have access to PIN comparison data represented as stored multiple combinations of digit subsets of the actual PIN, such that at least one digit in the digit sequence of the actual PIN is missing from the multiple combinations of the stored digit subsets. For example, in the case where one digit is missing from the actual PIN of a four digit PIN, i.e. D1, D2, D3, D4 representing the four digits, the digit subsets stored as PIN comparison data would be “D1, D2, D3”, “D2, D3, D4”, “D1, D3, D4”, and “D1, D2, D4”, such that the digit subset 27 entered by the cardholder into the user interface 104 of the card reader terminal 12 is compared to the digit subsets in the PIN comparison data for PIN authentication. Alternatively, the stored PIN comparison data would not be the actual multiple combinations of the digit subsets, rather stored comparison result data representing the comparison result (e.g. a PIN verification value PVV representative of the at least one digit missing) between the possible digit subsets and the entered digit subset 27. In this case, the transaction processor 7 could also use question information in the authorization request 26 indicating which of the digit(s) in the PIN code sequence was/were omitted as instructed in the question 15, in order to match the submitted digit subset 27 with the actual PIN code.

It is recognised that that the transaction processor 7 of the processing system 14 can have access to PIN comparison data represented as stored multiple combinations of digit subsets of the actual PIN, such that at least one digit in the digit sequence of the actual PIN is extra (e.g. dummy digit(s)) for multiple combinations of the stored digit subsets). For example, in the case where one digit is extra to the actual PIN of a three digit PIN, i.e. D1, D2, D3 representing the three digits with DD representing the dummy digit, the digit subsets stored as PIN comparison data would be “D1, D2, D3, DD”, “DD, D1, D2, D3”, “D1, DD, D2, D3”, and “D1, D2, DD, D3”, such that the digit subset 27 entered by the cardholder into the user interface 104 of the card reader terminal 12 is compared to the digit subsets in the PIN comparison data. Alternatively, the stored PIN comparison data would not be the actual multiple combinations of the digit subsets, rather stored comparison result data representing the comparison result (e.g. a PIN verification value PVV representative of the at least one digit extra) between the possible digit subsets and the entered digit subset 27. In this case, the transaction processor 7 could also use question information in the authorization request 26 indicating which of the digit(s) in the PIN code sequence was/were added as instructed in the question 15, in order to match the submitted digit subset 27 with the actual PIN code. Alternatively, the card reader terminal 12 could choose to not send the dummy digit(s) to the transaction processor 7, rather the card reader terminal 12 would strip the dummy digit(s) from the submitted digit subset 27 based on knowledge of the question 15 posed to the cardholder (e.g. if the fourth digit instructed in the question 15 to be added to a three digit code, then the card reader terminal 12 would strip the fourth digit of the received digit subset 27 and only transmit the first three digits to the transaction processor 7).

In view of the above, it is recognised that the previous question 15 asked to the cardholder (i.e. the question 15 posed that resulted in the digit subset 27 entered by the cardholder in a previous—e.g. last—transaction) could be stored/retained by the system 10, for example, by the card reader terminal 12 or the network of card reader terminals 12, by the processing system 14 such as by the transaction processor 7, by the card data 23 itself such that the previous question 15 is stored in the storage media 19, or a combination thereof.

### Payment Card 20

Referring again to FIG. 1, it recognized that the payment card 20 can be a magnetic stripe card having a physical card storage medium 19 embodied as a magnetic stripe or can be a chip card having the physical card storage medium 19 embodied as a chip as is known in the art. The card storage medium 19 can contain card data 23 including stored PIN information. Card account data 23 stored in the card storage medium 19 can be in a number of machine readable formats. Fields of the card information can vary, but the most common include: Name of card holder; Account number; Expiration date; Verification/CVV code; and PIN number.

It is also recognised that the card data 23 can store multiple combinations of digit subsets of the actual PIN, such that at least one digit in the digit sequence of the actual PIN is missing from the multiple combinations of the stored digit subsets. For example, in the case where one digit is missing from the actual PIN of a four digit PIN, i.e. D1, D2, D3, D4 representing the four digits, the digit subsets stored as card data 23 would be “D1, D2, D3”, “D2, D3, D4”, “D1, D3, D4”, and “D1, D2, D4”, such that the digit subset 27 entered by the cardholder into the user interface 104 of the card reader terminal 12 is compared to the digit subsets in the card data 23. Alternatively, the stored card data 23 would not be the actual multiple combinations of the digit subsets, rather stored comparison result data 23 representing the comparison result (e.g. a PIN verification value PVV representative of the at least one digit missing) between the possible digit subsets and the entered digit subset 27.

It is also recognised that the card data 23 can store multiple combinations of digit subsets of the actual PIN, such that at least one digit in the digit sequence of the actual PIN is extra (e.g. dummy digit(s)) for multiple combinations of the stored digit subsets. For example, in the case where one digit is extra to the actual PIN of a three digit PIN, i.e. D1, D2, D3 representing the three digits with DD representing the dummy digit, the digit subsets stored as card data 23 would be “D1, D2, D3, DD”, “DD, D1, D2, D3”, “D1, DD, D2, D3”, and “D1, D2, DD, D3”, such that the digit subset 27 entered by the cardholder into the user interface 104 of the card reader terminal 12 is compared to the digit subsets in the card data 23. Alternatively, the stored card data 23 would not be the actual multiple combinations of the digit subsets, rather stored comparison result data 23 representing the comparison result (e.g. a PIN verification value PVV representative of the at least one digit extra) between the possible digit subsets and the entered digit subset 27.

The card storage medium 19 of the payment card 20 can provide for identification, authentication, data 23 storage and/or application processing with respect to use of the payment card 20 for payment transactions involving the use of a PIN entered by the cardholder, which is verified by the card reader terminal 13 (e.g. in the case of an offline transaction) and/or the payment transaction processing system 14 (e.g. in the case of an online transaction). The payment card 20 can be a card such as but not limited to: a debit card; a credit card; a pre-paid credit card or a loyalty card, for example. In the case of a pre-paid credit card, it is not a true credit card since no credit is offered by the card issuer, rather the card-holder spends money which has been “stored” via a prior deposit by the card-holder or someone else, such as a parent or employer, and can be used in similar ways just as though it were a regular credit card.

In terms of a magnetic stripe card 20, the payment card 20 is a type of card capable of storing data 23 by modifying the magnetism of tiny iron-based magnetic particles on a band of magnetic material employed as the card storage medium 19. The magnetic stripe 19 is read by physical contact and swiping past a reading head of the card reader terminal 12. Magnetic stripe cards are commonly used in credit cards, identity cards, and transportation tickets and can also contain an RFID tag, a transponder device and/or a microchip mostly used for business premises access control or electronic payment.

In terms of a chip card 20, the payment card 20 can be referred to a smart card 20, chip card 20, or integrated circuit card (ICC) 20 that can be any pocket-sized card with embedded integrated circuits (e.g. computer hardware 21 including the card storage medium 19), which can access and process data 23 of the financial transaction on the payment card 20 such as entered PIN data 23 as well as other data 23 involved in the interaction of the payment card 20 with the card reader terminal 12. This implies that the computer hardware 21 can receive input data 23 which is processed—by way of the ICC applications (e.g. a cryptoprocessor)—and delivered as an output (e.g. a cryptogram). The computer hardware 21 can contain non-volatile memory storage components, some specific security logic, volatile memory and microprocessor components. It is recognized that the card data 23 can be stored on the computer hardware 21 in encrypted form and can include data such as but not limited to: cardholder name; card number; card expiry date; and a list of data (e.g. tags) that are used in the approve or decline decision of a transaction request 24.

In terms of the chip card 20 being an NFC tag device, these contain data 23 and are read-only but can also be rewriteable. The chips 19 can be custom-encoded by their manufacturers or use the specifications provided by the NFC Forum, an industry association charged with promoting the technology and setting key standards. The tags devices can securely store personal data 23 such as debit and credit card information, loyalty program data, PINs and networking contacts, among other information. There currently are four types of tag devices which provide different communication speeds and capabilities in terms of configurability, memory, security, data retention and write endurance. Tag devices currently offer between 96 and 4,096 bytes of memory for the data 23.

Another standard, ISO/IEC 7816-3, defines the transmission protocol 52 between chip cards 20 and readers (e.g. card reader device 12 configured by the processing system 17). Using this protocol 52, data 23 is exchanged between the payment card 20 (e.g. the computer hardware 21 providing a cryptographic application) and the merchant system 13 in application protocol data units (APDUs). This comprises sending a command via the communication interface 102 to the computer hardware 21 of the card, the computer hardware 21 processing the command, and sending a response that is received by the communication interface 102 and then processed by the processing system 17 (including the card reader 12) of the merchant system 13. The protocol 52 can use the following example commands: application block (of the cryptographic application); application unblock; card block; external authenticate (7816-4); generate application cryptogram; get data (7816-4); get processing options; internal authenticate (7816-4); PIN change/unblock; read record (7816-4); select (7816-4); and verify (7816-4). The configuration of the computer hardware 21 of the chip 19 provides, via the cryptographic application, an integrated security module with (Data Encryption Standard) DES, Triple-DES encryption and Master/Session and (Derived Unique Key Per Transaction) DUKPT key management schemes. Other encryption schemes can include RSA and (Secure Hash Algorithm) SHA to provide authentication of the card 20 to the processing merchant system 13 and/or the card issuer's host processing system 14. It is recognized that the cryptographic application (implementing the encryption scheme(s)) can be embodied as software, hardware (i.e. IC) or a combination of both, however due to desired processing speeds IC embodiments are currently preferred.

The computer hardware 21 of the chip 19 can include a secure cryptoprocessor as a dedicated computer on a chip or microprocessor for carrying out cryptographic operations (e.g. for generating the cryptogram), embedded in a packaging with multiple physical security measures, which give it a degree of tamper resistance. The purpose of a secure cryptoprocessor is to act as the keystone of a security sub-system, reducing the need to protect the rest of the sub-system with physical security measures. Cryptoprocessors input program instructions in encrypted form, decrypt the instructions to plain instructions which are then executed within the same cryptoprocessor chip where the decrypted instructions are inaccessibly stored. Data processed by a cryptoprocessor is also frequently encrypted. The cryptoprocessor chip can be an embedded microchip that stores information in a secure, encrypted format.

It is also recognized that the payment card 20 can be referred to as contactless smart cards or proximity cards where the card reader terminal 12 of the merchant system 13 uses wireless communication protocols 52, such as Near Field Communication (NFC), to communicate with chip computer hardware 21. The wireless communication protocol 52 standards applicable to contactless smart cards or proximity cards can refer to the older 125 kHz devices or the newer 13.56 MHz contactless RFID cards (in which the chip 19 is an RFID chip embedded within the card substrate). Modern proximity cards are covered by the ISO/IEC 14443 (proximity card) standard. Payment cards 20 that include an embedded antenna and a microchip (e.g. in the computer hardware 21) can communicate wirelessly with the communication interface 102 of the card reader terminal 13, via a chip 19 antenna.

### PIN

In terms of the merchant, it can be the merchant's financial institution (e.g. of the processing system 14) that processes the payment transaction resulting from use of the payment card 20 for ultimately providing transaction settlement that gives the merchant funds to pay for products and services bought using the card. On the other hand, the Issuer is the financial institution (e.g. of the processing system 14) that provided the payment card 20 to the cardholder to enable them to pay for products and services using that card, such that the Issuer typically only charges the cardholder an annual user fee and interest charges on unpaid card balances.

The combination of chip 19 cryptogram generation and PIN confirmation is a preferred way to accept card payments when the payment card 20 and cardholder are present, however it is recognised that PIN confirmation can also be used for magnetic stripe based payment cards 20. The PIN can be defined as a secret numeric (however can also include alpha or other non-numeric characters) password shared between the cardholder and the payment card transaction system 10, for use in authentication of the cardholder to the system 10. The actual number of digits of the PIN can be 4 digits and preferably 6 or more digits.

Historically, the payment card 20 is inserted physically into the POS terminal 12 and the PIN entered by the cardholder using a keypad of the terminal 12. Therefore, card holders had greater control over chip cards because the card remained in the possession of the cardholder. In this case, traditional electronic verification systems of the processing system 14 and/or the card reader terminal 12 allowed merchants to verify in a few seconds that the card 20 was valid and the card customer had sufficient credit to cover the purchase, allowing the verification to happen at time of purchase. This traditional verification is enabled by using the physical card payment terminal or point-of-sale (POS) system with a communications link to the merchant's acquiring bank. However fraudulent activity (such as reading and copying PIN information) by unscrupulous merchants (e.g. “eavesdroppers”, “man in the middle attackers”) remains a concern.

Therefore, to help technically address the above noted prior art technical deficiencies, in operation of the payment application 16 configured card reader terminal 12, the personal identification number (PIN) associated with the payment card 20 of the cardholder is authenticated by leveraging that the PIN is a code having a sequence of digits. The payment application 16 coordinates the authenticating of the PIN by presenting a PIN entry request 15 to the cardholder on the user interface 104 including identifying a digit subset of the code, such that the digits in the digit subset is at least one digit less than the digits of the code.

In this example, it is understood that the digit subset of the code can mean that the actual number of digits requested by the user interface is less than the actual number of digits of the code (i.e. the PIN entry request 15 states to enter the PIN by skipping certain digit(s)—for example “enter the PIN as “_{——}X_” which means for the cardholder to enter only three digits as the digit subset such that the third digit in the code sequence is not entered into the user interface 104 or skipped to give the digit subset is at least one digit less than the digits of the code). It is recognised that any number (e.g. 1 digit, 2 digits, etc.) of skipped digits can be specified by the PIN entry request 15, as desired.

Alternatively, it is understood that the digit subset of the code can mean that the actual number of digits requested by the user interface is the same as the actual number of digits of the code (i.e. the PIN entry request states to enter the PIN by inserting certain substitute digit(s)—for example “enter the PIN as “_{——}?_” which means for the cardholder to enter four digits as the digit subset such that the third digit in the code sequence is a random digit that is not part of the actual code). One example of this embodiment is the entry of the digits 1, 2, 7, 4 but the actual pin code is 1, 2, 3, 4, meaning that the third digit entered of the digit subset is incorrect on purpose and is not part of the digits of the code (e.g. the digit subset is at least one digit less than the digits of the code as the digit subset only contains three correct digits of the actual four digits of the code).

Alternatively, it is understood that the digit subset of the code can mean that the actual number of digits requested by the user interface is the same as the actual number of digits of the code (i.e. the PIN entry request states to enter the PIN by inserting certain substitute digit(s)—for example “enter the PIN as “_{——}5_” which means for the cardholder to enter four digits as the digit subset such that the third digit in the code sequence is an assigned digit by the instructions 15 that is not part of the actual code). One example of this embodiment is the entry of the digits 1, 2, 5, 4 but the actual pin code is 1, 2, 3, 4, meaning that the third digit entered of the digit subset is incorrect on purpose and is not part of the digits of the code (e.g. the digit subset is at least one digit less than the digits of the code as the digit subset only contains three correct digits of the actual four digits of the code).

Upon receiving the PIN entered as the digit subset via the user interface 104 of the card reader device 12, for an offline transaction, the card reader terminal 12 can access the card storage media 19 (e.g. chip or magnetic stripe) using the communication protocol 52 to look up the PIN (i.e. stored in the card data 23) and have a comparison performed of the looked-up PIN with the received PIN (for example as performed by the processor 108 of the card reader terminal 12 and/or by the computer hardware 21 in the case of a chip card 20). The cardholder is granted access when the PIN entered matches with the stored PIN, by knowing which of the digits of the digit subset is either missing or incorrect on purpose, as further described below. In particular, it is advantageous in use of the payment application 16 for PIN submission and confirmation for the cardholder, as this PIN information is not entered in unencrypted form (i.e. by using the keypad of the merchant).

Alternatively, upon receiving the PIN entered as the digit subset via the user interface 104 of the card reader device 12, in an online transaction via the communication interface 102 using the communication protocol 52 over the network 11, the digit subset is sent over to the transaction processor 7 for comparison with the PIN stored locally. The cardholder is granted access when the digit subset entered matches with the stored PIN, by the transaction processor 7 knowing which of the digits of the digit subset is either missing or incorrect on purpose, as further described below. In particular, it is advantageous in use of the payment application 16 for PIN submission and confirmation for the cardholder, as this PIN information is not entered in unencrypted form (i.e. by using the keypad of the merchant).

Alternatively, it is understood that the digit subset of the code can mean that the actual number of digits requested by the user interface is greater than the actual number of digits of the code (i.e. the PIN entry request 15 states to enter the PIN by adding certain dummy digit(s)—for example “enter the PIN as “_{————}?” which means for the cardholder to enter five digits as the digit subset such that the fifth digit in the code sequence is entered into the user interface 104 to give the digit subset is at least one digit greater than the digits of the code). As discussed above, the dummy digit “?” can be left up to the cardholder to choose and/or can be assigned an actual value by the payment application 16 (e.g. displayed as “_{————}5”, such that the digit 5 is specified as the dummy digit in the fifth position of the digit sequence). Alternatively, the extra digit(s) can be positioned in the interior (e.g. “_{—}5_{———}”) of the digit subset sequence, at the beginning (e.g. “5_{————}”) of the digit subset sequence, as desired. It is recognised that any number of extra dummy digits can be specified by the PIN entry request 15, as desired.

### Card Reader Terminal 12

The card reader terminal 12 is configured through the payment application 16 and the communication interface 102 to communicate directly with storage media 19 (e.g. integrated circuit (IC)) of a payment card 20 and/or the processing system 14 using the communication protocols 50,52. The transaction request 24 can include, for example, merchant identification information, POS type (such as in person local transaction or remote network transaction), and transaction amount and/or transaction type (such as retail item purchase, restaurant purchase, digital product purchase such as online music, and/or subscription or service registration involving subscription/registration fees). Further, it is recognised that the card data 23 can be stored on the storage media 19 as read only and/or as read and write data (i.e. can be modified such as in the case where a card PIN is changed).

The payment application 16 of the card reader terminal 12 is configured to initiate the digit subset request on the display using the PIN entry instructions 15 (including the requested digit subset 27), for example electronically by a POS terminal involving operation of the card reader mechanism 118 and PIN entry pad of the user interface 104. The payment application 16 can be further configured to communicate through the communication interface 102 (for example using communication protocols 52) with the chip 19 and/or the transaction processor 7 for: sending an authentication or confirmation request 26 of the personal identification number (PIN) information 23 (e.g. stored on the chip 19 and/or stored by the processing system 14 and therefore accessible by the transaction processor 7) using the digit subset 27 entered by the cardholder.

In one embodiment, as it is recognised that for smaller amount financial transactions (e.g. less than a specified amount threshold such as $50), entry of and authentication of the PIN authentication request 26, including digit subset 27, can be sent to the chip 19 of the payment card 20 in order to receive cryptogram data 28 (for example including payment card account number and expiry date) from the chip 19 in a transaction response 29 (cryptogram) (i.e. indicating submitted digit subset 27 matches PIN information 23 stored on the chip 19). In the case of offline authentication, this interaction with the chip 19 may be sufficient to authenticate the digit subset 27, of the digit subset 27 may not be a requirement of the financial transaction to involve the transaction processor 7 of the payment processing system 14. (i.e. processing the financial transaction for smaller monetary amounts without the presence of PIN authentication data issued by the processing system 14).

In another embodiment, the PIN authentication request 26, including digit subset 27, can be sent to the chip 19 of the payment card 20 in order to receive cryptogram data 28 (for example including payment card account number and expiry date) from the chip 19 in a transaction response 29 (cryptogram), i.e. indicating submitted digit subset 27 matches PIN information 23 stored on the chip 19. In the case of online authentication, this interaction with the chip 19 would not be sufficient to authenticate the digit subset 27 and therefore the digit subset 27 (e.g. in the form of the cryptogram) would be sent to the transaction processor 7 for further verification (e.g. comparison of the digit subset data 27 with the PIN data accessible by the transaction processor 7) as processor response data 30 in the transaction response 29 by the transaction processor 7 back to the card reader terminal 12.

Further, it is understood that the authentication request 26 sent to the chip 19 can include chip commands (further described below) used by the computer hardware 21 of the chip 19 to understand and confirm the submitted digit subset 27. The payment application 16 is also configured to send over a communications network 11, using a network communications protocol 50 (e.g. TCP/IP, HTTP, HTTPS, etc.), transaction authorization request data 32 to the payment transaction processing system 14, such that the transaction authorization request data 32 includes both the cryptogram data 28 and other transaction (e.g. card number, transaction amount and/or any other of the card data 23). Upon receipt of the transaction authorization data 32 by the payment transaction processing system 14, the payment transaction processing system 14 generates a transaction authorization code 34 and then sends over the network 11 the transaction authorization code 34 (e.g. indicating transaction authorization request data 32 is either approved or declined) to the merchant system 13 (either directly or via the card reader terminal 12).

In terms of online transactions, these can be defined when PIN authentication has been requested of the transaction processor 7 by the card reader terminal 12, wherein the entered digit subset 27, an indication of which digit(s) in the digit sequence of the actual PIN code are missing or are extra, and/or the cryptogram (e.g. ARQC) is sent in the authorisation message to the transaction processor 7. In terms of the ARQC, it is recognised that the card 20 generates the ARQC, its format depends on the card application 21, and the ARQC created by the card application is a digital signature of the transaction details which can be checked in real time by the card issuer (e.g. transaction processor 7). The transaction processor 7 can respond to the authorisation request with a response code (accepting or declining the transaction), an authorisation response cryptogram (ARPC) and/or optionally an issuer script (a string of commands to be sent to the card 20). For example, the issuer script can contain information for storing on the card as card data 23 representing which digit(s) of the digit sequence was/were missing in the PIN entry instructions 15. For example, the issuer script can contain information for storing on the card as card data 23 representing which digit(s) of the digit sequence was/were extra in the PIN entry instructions 15. Accordingly, it is recognised that the authorization request 26 sent to the transaction processor 7 by the card reader terminal 12 could include digit information based on the entered digit subset 27 as well as question information based on the question 15 presented to the cardholder, for example the authorization request could include the information “1,2,3” as the digit information and “−4” representing that the fourth digit is missing from the PIN code (e.g. the question 15 posed was “Enter your PIN as _{———}X” indicating that only the first three digits of the code sequence were to be included and the fourth digit of the sequence was to be omitted).

In general, the question information and/or the question 15 itself can included information on: which digit(s) of the code sequence are included and which digit(s) of the sequence are omitted; which digit(s) of the code sequence are included; or which digit(s) of the sequence are omitted, as desired.

Alternatively, in general, the question information and/or the question 15 itself can included information on: which digit(s) of the code sequence are included and which digit(s) of the sequence are added; which digit(s) of the code sequence are included; or which digit(s) of the sequence are added, as desired.

In terms of offline transactions, these can be defined when PIN data authentication is a cryptographic check to validate the card 20 using public-key cryptography as implemented via the payment application 16 of the card reader terminal 12. There can be three different processes that can be undertaken depending on the card: static data authentication (SDA) provides data read from the card has been signed by the card issuer; dynamic data authentication (DDA) provides protection against modification of data and cloning; combined DDA/generate application cryptogram (CDA) combines DDA with the generation of a card's application cryptogram to assure card 20 validity.

In operation of the card reader terminal 12, the computer framework 106 (including the processor 108 and memory 110) can be configured via the payment application 16 for authenticating the personal identification number (PIN) associated with the payment card 20 of the cardholder, wherein the PIN is a code having a sequence of digits. The computer processor 108 coupled to the physical memory 110 is such that the computer processor is programmed to coordinate the authenticating of the PIN by: presenting via the user interface 104 the PIN entry request 15 to the cardholder including identifying a digit subset of the code, such that the digits in the digit subset is at least one digit less than the digits of the code; receiving via the user interface 104 the digit subset 27 in response to the PIN entry request 15; sending an authentication request 26 (e.g. to the card 20 and/or to the transaction processor 7) based on the digit subset 27; receiving an authentication response 28 including response data; and presenting response instructions 15 via the user interface 104 to the cardholder based on the response data, the response instructions 15 including information representative of whether the PIN was successfully authenticated or not using the digit subset.

Additional steps performed by the payment application 16 can be querying the card data 23 to determine which digit or digits of the sequence of digits was or were not included in the digits of the digit subset 27 in a previous PIN entry request 15 and generating the PIN entry request 15 for the current transaction to identify a different digit subset to that of the digit subset of the previous PIN entry request 15.

### Payment Application 16

It is recognised that the authentication request 26 of the payment application 16 can include transaction data such as but not limited to: transaction amount; currency; merchant identification information used to uniquely identify the merchant with the transaction payment processing system 14; a description of products or services being purchased; date of purchase; merchant location; identification information of a network address of the payment processing system 14 used by the merchant; and method of payment selected by cardholder (e.g. VISA™, Mastercard™, Debit, etc.). For example, the authentication request 26 can include one or more Terminal action codes (TACs), including a generate application cryptogram command. Based on a decision (offline, online, decline), the authentication request 26 can include a request of one of the following encrypted vales (e.g. cryptograms) generated from the chip 19: Transaction certificate (TC)—Offline approval; Authorization Request Cryptogram (ARQC)—Online authorization; or Application Authentication Cryptogram (AAC)—Offline decline. The card reader terminal 12 can expect to receive response data 28 as one or more Issuer action codes (IACs), which are provided in the transaction response 29 transmitted by the hardware 21 of the chip 19. The response data 28 of the transaction response 29 can include the appropriate cryptogram (e.g. digital signature or encrypted value). It is recognized that the response data 28 created by the hardware 21 of the chip 19 can represents the digital signature of the transaction details which can be checked in real time by the card issuer (i.e. the transaction payment processing system 14). For example, the response data 28 can include the encrypted value embodying card number, card and/or expiry date, in addition to selected data of the expected transaction data.

The cryptogram of the response data 28 can be defined as the encrypted value based on specific inputs for an individual card and transaction that makes each transaction unique. Since only the chip 19 itself can create a valid cryptogram, the authorizing host (e.g. the payment processing system 14) can confirm that the actual card is present during processing of the transaction between the card reader terminal 12 and the card 20 during interaction of the cardholder with the merchant system 13. In addition, the cryptogram 28 is generated using secret keys inside the chip 19 (as provided by the hardware 21—e.g. via a crypto processor), so key management is not needed for merchants. The card issuer controls key management entirely. Therefore, it is recognised that a chip transaction generates a unique transaction and because each transaction generates a different ID.

The payment application 16 is configured to collect digit subset data 27 entered by the cardholder via the user interface 104 (e.g. keypad) of the card reader terminal 12. The PIN authentication request 26, including the data 27, is then sent via the communication interface 102 to the chip 19 as the PIN authentication request 26. It is recognized that the PIN authentication request 26 can include one or more relevant TACs. The payment application 16 can expect to receive PIN authentication data as one or more Issuer action codes (IACs), for example, which are provided in an authentication response transmitted by the hardware 21 of the chip 19. The PIN authentication data of the authentication response can include the appropriate decision, either Approved in the case where the data 27 matched the stored PIN data 23 of the hardware 21 or Declined in the case where the PIN data 27 did not match the stored PIN data 23 of the hardware 21.

It is recognized that wireless communication between the communication interface 102 of the card reader terminal 12 and the hardware 21 of the chip 19 can be in a specific order or sequence, as implemented by the payment application 16. For example, in a first embodiment, the PIN authentication request 26 can be submitted first to the hardware 21, and the subsequent sending of the transaction request is only done or otherwise accepted in the event where the PIN authentication data (received the authentication response 31 is confirmed as Approved. In other words, the payment application 16 would not send the transaction request (or the hardware 21 can refuse to accept and/or respond with the requested cryptogram) in the event that the PIN authentication data indicates Declined. This is an example of a two stage interaction between the payment application 16 and the hardware 21 of the chip 19, such that Approval of the PIN authentication request 26 (i.e. the submitted data 27 is deemed by the hardware 21 to match the stored PIN data 23) must be received before transaction request 25 can be sent or otherwise satisfied.

In a second embodiment, first the transaction request is submitted before the PIN authentication request 26 is submitted. In another embodiment, both the transaction request and the PIN authentication request 26 are sent to the hardware 21 in the same message.

Referring again to FIG. 1, the payment application 16 can be configured to collect the PIN authentication data (indicating Approved) and the transaction response 29 data (e.g. the cryptogram 28) and forward these in the transaction authorization request 26 to the payment transaction processing system 14. In return, the payment transaction processing system 14 generates the transaction authorization code and then sends over the network lithe transaction authorization code (e.g. indicating transaction authorization request 26 is either approved or declined) to the merchant system 13 (either directly or via the card reader terminal 12). The payment transaction processing system 14 can also send details concerning whether the transaction was accepted or declined. It is recognized that the transaction authorization request 26 can include an authorisation response cryptogram (ARPC) and optionally an issuer script (a string of commands to be sent to the card hardware 21).

Currently criminals will take a number of cloned cards to an ATM 12 to withdraw cash. From the systems 10 point of view, these are normal transactions, as the criminal has both cloned cards 20 and valid PINs. In implementation of the digit subset 27 (e.g. Transaction PIN) as described herein (e.g. via posed questions 15, received answers 15 including the digit subset 27, and authorization requests 26 submitted to the card and/or the transaction processor 7), the level or degree of cloned cards 20 usage could change, as the generation of Transaction PIN requests 15 can be a random process and for the majority of transactions this will force the criminal to try to guess the unknown digits. This can lead to what appears to the system 10 as a large number (at least 50% or some other predefined failure threshold used by the card reader terminals 12) of customers failing to enter a valid PIN at a particular ATM 12 over a short (e.g. predefined) period of time.

This behaviour of the card reader terminal 12 experiencing a highly unusual degree of fraud activity (e.g. defined as PIN transactions failing over the predefined failure threshold within a predefined period of time—e.g. 50% failure rate in the span of 5 minutes at a particular bank machine 12) would be detectable by the card reader terminal 12 (for example as configured in the payment application 16). This could cause the card reader terminal 12 inform the processing system 14 (e.g. the ATM switch), be informed by the processing system 14, and/or note to itself that the particular card reader terminal 12 is being compromised, and should lead to a temporary block of subsequent transaction activity (e.g. cash withdrawals from that particular ATM). This change in behaviour of the card reader terminals 12 based on PIN transactions failing over the predefined failure threshold within a predefined period of time could limit the criminals ability to withdraw large amounts of cash from a single visit, and significantly reduce the attractiveness of this particular type of skimming fraud.

### Example Operation of the System 10

Referring to FIGS. 1, 2 and 3, shown is an example operation 300 of a payment application 16 configured for coordinating processing of a cardholder present financial transaction between the cardholder, the card reader application 12 and optionally the processing system 14.

At step 302, the method for authenticating the personal identification number (PIN) associated with the payment card 20 of a cardholder, such that the PIN is a code having a sequence of digits, comprises presenting a PIN entry request 15 to the cardholder including identifying a digit subset of the code, such that the digits in the digit subset is at least one digit different (e.g. less or more) than the digits of the code. At step 304, the cardholder enters the digit subset 27 into the user interface 194 of the card reader terminal 12 which then receives the digit subset 27 in response to the PIN entry request 15. At step 306, the card reader terminal 12 sends an authentication request based on the digit subset. At step 308, the card reader terminal 12 receives an authentication response including response data. At step 310, the card reader terminal 12 presents the PIN response 15 on the user interface 104 to the cardholder based on the response data, the response 15 including information representative of whether the PIN was successfully authenticated or not using the digit subset 27.

### Computer Device 8

Referring to FIG. 2, each computer device 8 used to implement the card reader terminal 12 can be a wireless-enabled (e.g. WiFi, WAN, etc.) device, or wired device. In addition, the wireless communications are not limited to only facilitating transmission of text data (e.g. encrypted) and can therefore be used to transmit image data, audio data or multimedia data, for example, as desired. It is also recognised that the computer device 8 can have a wireless enabled communication interface onboard (i.e. as part of the computer hardware) or as a coupled peripheral device (off board computer hardware—not shown) that acts an intermediary wireless communication device for implementing (e.g. by proxy) the wireless communication protocol 52 between the wired network interface of the computer 8 and the chip 19.

As shown in FIG. 2, the computer device 8 comprises the communication interface 102, the user interface 104, and a data processing system 106 in communication with the communication interface 102 and the user interface 104. The network interface 102 can comprise one or more antennas for wireless communication over the communications network 11. Preferably, the user interface 104 comprises a data entry device (such as keyboard, microphone, touch screen or writing tablet), and a display device (such as an LCD display that could also be configured as the touch screen).

The data processing system 106 includes a central processing unit (CPU) 108, otherwise referred to as a computer processor, and a non-volatile memory storage device (e.g. DISC) 110 (such as a magnetic disc memory or electronic memory) and a read/write memory (RAM) 112 both in communication with the CPU 108. The memory 110 includes data which, when loaded into the RAM, comprise processor instructions for the CPU 108 which define memory objects for allowing the computer device 8 to communicate with the chip 19 and the processing system 14 (e.g. one or more processing servers) over the communications network 11, as well as optionally with the merchant system 17 (e.g. a website running on a merchant computer—not shown—and accessed via the network 11). The computer device 8, and the processor instructions for the CPU 108 will be discussed in greater detail below. The data processing system 106 can include the card reading mechanism 118 (as is known in the art.

The CPU 108 is configured for execution of the payment application 16 (see FIG. 2) for facilitating communication between the processing system 14, optionally the merchant system 17, the device 9, and the chip 19 of the payment card 20. For example, it is recognised that the application 16 is used to coordinate the communications between the various devices 8,9 over the network 11 and to wirelessly communicate with the hardware 21 of the chip 19 (at least for purposes of providing and confirming acceptance of the PIN data 27 with the hardware 21), and as such the application 16 functionality can be implemented by the CPU 108 to facilitate the generation, receipt, and processing of the wireless communications.

The CPU 108 facilitates performance of the device 8 configured for the intended task (e.g. of the respective module(s) of the payment application 16) through operation of the communication interface 102, the user interface 104 and other application programs/hardware (e.g. web browser made available to the payment application 16) of the computer device 12 by executing task related instructions. These task related instructions can be provided by an operating system, and/or software applications located in memory, and/or by operability that is configured into the electronic/digital circuitry of the processor(s) 108 designed to perform the specific task(s). Further, it is recognized that the device infrastructure 106 can include a computer readable storage medium 110 coupled to the processor 108 for providing instructions to the processor 108 and/or to load/update the instructions. The computer readable medium 110 can include hardware and/or software such as, by way of example only, memory cards such as flash memory or other solid-state memory.

Further, it is recognized that the computer device 8 can include the executable applications comprising code or machine readable instructions for implementing predetermined functions/operations including those of an operating system and the payment application 16, for example. The processor 108 as used herein is a configured device and/or set of machine-readable instructions for performing operations as described by example above, including those operations as performed by any or all of the modules. As used herein, the processor 108 may comprise any one or combination of, hardware, firmware, and/or software. The processor 108 acts upon information by manipulating, analyzing, modifying, converting or transmitting information for use by an executable procedure or an information device, and/or by routing the information with respect to an output device. The processor 108 may use or comprise the capabilities of a controller or microprocessor, for example.

### Computer Device 9

Referring to FIG. 3, each processing system device 8 (e.g. for implementing the transaction processor 7) can include a wireless-enabled (e.g. WiFi, WAN, etc.) device, or wired telephone. It is also recognised that the computer device 9 can be a desktop computer, however preferably is a server device or series of server devices. As shown in FIG. 3, the computer device 9 comprises the communication interface 202, the user interface 204, and a data processing system 206 in communication with the communication interface 202 and the user interface 204. The network interface 202 can comprise one or more antennas for wireless communication over the communications network 11. The user interface 204 can comprise a data entry device (such as keyboard, microphone, touch screen or writing tablet), and a display device (such as an LCD display that could also be configured as the touch screen). It is recognised that user interface 204 is separate from the user interface 104 of the cardholder computer device 8. Further, it is recognised that the network communication interface 202 is separate from the communication interface 102 of the cardholder computer device 8, such that the network communication interface 202 and the communication interface 102 are configured to separately and independently communicate with one another using the network communication protocol 50 over the communication network 11.

The data processing system 206 includes a central processing unit (CPU) 208, otherwise referred to as a computer processor, and a non-volatile memory storage device (e.g. DISC) 210 (such as a magnetic disc memory or electronic memory) and a read/write memory (RAM) 212 both in communication with the CPU 208. The memory 210 includes data which, when loaded into the RAM, comprise processor instructions for the CPU 208 which define memory objects for allowing the computer device 9 to communicate with the computer device 8 over the communications network 11. The computer device 9 can optionally be embodied as a network (e.g. web) service running on a financial institution computer and accessed via the network 11. The computer device 9, and the processor instructions for the CPU 208 will be discussed in greater detail below.

The CPU 208 is configured for execution of the transaction processor 7 (see FIG. 1) for facilitating communication between the payment processing system 14 and the computer device 8. For example, the system 14 functionality can be implemented by the CPU 208 to facilitate the generation, receipt, and processing of the network 11 communications (both wired and wireless) using network communication protocol 50.

The CPU 208 facilitates performance of the mobile device 9 configured for the intended task (e.g. of the respective module(s) of the system 14 related to transaction generation, processing and confirmation through operation of the communication interface 202, the user interface 204 and other application programs/hardware (e.g. network service made available to the payment application 16) of the computer device 9 by executing task related instructions. These task related instructions can be provided by an operating system, and/or software applications located in memory, and/or by operability that is configured into the electronic/digital circuitry of the processor(s) 208 designed to perform the specific task(s). Further, it is recognized that the device infrastructure 206 can include a computer readable storage medium 210 coupled to the processor 208 for providing instructions to the processor 208 and/or to load/update the instructions. The computer readable medium 210 can include hardware and/or software such as, by way of example only, memory cards such as flash memory or other solid-state memory.

Further, it is recognized that the computer device 9 can include the executable applications comprising code or machine readable instructions for implementing predetermined functions/operations including those of an operating system and the system 14 and the processor 7 functionality, for example. The processor 208 as used herein is a configured device and/or set of machine-readable instructions for performing operations as described by example above, including those operations as performed by any or all of the system 14 and the processor 7 functionality. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example.

### Additional Example Embodiments

The security of Automated Cash Machine (ATM) transactions can be significantly enhanced by the adoption of a “transaction PIN” (e.g. digit subset 27) generated in some random manner from the customers “personalized PIN” (e.g. actual PIN). This system 10 uses a fixed personal PIN that the customer remembers but only to use a subset, chosen by the secure system, of this PIN to authenticate each individual transaction. This method of card 20 and PIN transaction could be significantly more secure than the traditional method, where the entire personal PIN is entered for every transaction. Specifically, use of the digit subset 27 as the entered PIN can reduce the probability of a fraudster being able to “skim” a customers card and PIN, at a cash machine, and use this information to fraudulently initiate and authenticate, subsequent transactions.

Bank Card skimming is a significant problem for the payment network, and consists of fraudsters attaching highly sophisticated hardware to the card slot of an ATM or point of sale machine, which allows them to copy the card data when the customer enters their card to initiate a transaction. This hardware is then removed after a period of time (normally a few hours), and the customer card data 23 thus obtained is used to produce fraudulent duplicate cards. Concurrently with copying the customer card data 23, various approaches (either visual or audio recording devices) are used to record the PIN code that the customer uses to authenticate the transaction. Traditionally the customer uses their entire (e.g. four) digit PIN for each, and every, transaction. Thus the fraudster by observing, and recording, all of the information contained in a single transaction has sufficient data to initiate subsequent fraudulent transactions.

The extent of Bank card fraud has lead to the automated payments network adopting ever escalating security measures in an attempt to reduce it. The adoption of chip and PIN technology has made it much harder for fraudsters to copy the relevant card data 23, and frequent physical inspection of the machines 12, has lead to ever more sophisticated measures in turn being adopted by fraudsters to obtain the transaction data that they require. Nevertheless, skimming fraud remains a significant problem even after the adoption of these traditional measures to combat it. The use of “transaction PINs” complements these traditional methods, and can be quickly and cheaply adopted by the payments network as a means to effectively reduce fraud, in a way which can not be combated by the fraudster.

As an example, assume that the customer uses a four digit personalized PIN of 2674. This PIN does not change and must be memorized by the customer. Under the traditional method this is always their transaction PIN, and is used for every transaction. Hence, if a fraudster is able to copy the customers card 20 during a transaction, using a skimming device, and record the PIN entered (in this case, 2674) then they have sufficient information to execute further transactions. They would simply produce a duplicate card and initiate a fraudulent transaction, when PIN authentication is requested they would enter the recorded PIN (in this case 2674) and successfully complete the fraudulent transaction.

Under the method implemented by the system 10 (via the payment application 16), the personalized PIN would be used to generate a transaction PIN with added or missing digit(s), by following the instructions on the screen. The simplest method is to omit one of the personalized PIN digits to generate the transaction PIN (digit subset 27). In this case, the screen could direct the customer to omit the second digit by displaying the message “_X_{——}” and the customer would enter the transaction PIN 274. Even if traditional security methods fail, and the fraudster successfully records this, it is not always sufficient to authenticate the next transaction, as they do not know the entire customer personalized PIN.

When using copied card data the system 10 might, for instance, request that the customer omit the third digit of their PIN “_{——}X_”, thus requiring 264 be entered as the next transaction PIN. The fraudster has no way of knowing the second digit required, as it was not part of the previous transaction PIN (274) that they observed, the fraudster must rely on probability theory the guess the required number, and will be successful approximately 50% of the time. This assumes that a single digit is randomly omitted from a four digit personal PIN to generate a transaction PIN, and that once initiated a correct PIN must be entered within three attempts, or the transaction is flagged as a potential fraud.

This simple omission of a single digit from a four digit personalized PIN to generate a transaction PIN could cut successful fraud by approximately 50%, assuming that the fraudster can also record the instructions given to the customer and so knows which digit was omitted.

Variations of this method of using transaction PINS can reduce the cases of fraud even more significantly, for instance using five or six digit PINs and omitting two or three numbers quickly reduces the probability of a successful skimming leading to a successful fraud, to well below 5%. It is also recognised that adding one or more dummy digits to the digit subset is also possible, as incorporated in the PIN entry instructions 15 provided to the cardholder.

While being appropriate for ATM security this use of a personal PIN and system generated directions, to generate a transaction PIN, is equally applicable to transactions at gas stations, merchant transactions, credit card transactions, etc. Indeed, any payment system where there is a risk of transaction data being duplicated can have it's security enhanced by this method.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

We claim:

1. A method for authenticating a personal identification number (PIN) associated with a payment card of a cardholder, the PIN being a code having a sequence of digits, the method comprising the steps of:
presenting a PIN entry request including identifying a digit subset of the code, such that the digits in the digit subset is at least one digit less than the digits of the code;
receiving the digit subset in response to the PIN entry request;
sending an authentication request based on the digit subset;
receiving an authentication response including response data; and
presenting a response to the cardholder based on the response data, the response including information representative of whether the PIN was successfully authenticated or not using the digit subset.

2. The method of claim 1, wherein the authentication request further includes the steps of: accessing by a card reader the code stored as card data in a physical memory of the payment card using the digit subset; obtaining a comparison result of a comparison between the code stored in the card data and the digit subset; and including the comparison result in the authentication request such that the authentication request is sent to a transaction processor over a communications network.

3. The method of claim 2, wherein the code is stored in the card data as a PIN verification value (PVV).

4. The method of claim 2, wherein the physical memory is a magnetic stripe and the card data is stored as track data recorded on the magnetic stripe.

5. The method of claim 2, wherein the physical memory is part of an integrated circuit (IC) attached to the payment card and the card data is accessed using application protocol data units (APDU).

6. The method of claim 5, wherein the comparison result is embodied in a cryptogram generated by a cryptogram processor of the IC such that the cryptogram is a transaction certificate (TC) in the case of offline approval or an authorization request cryptogram (ARQC) in the case of online authorization.

7. The system of claim 6, wherein the comparison result includes the ARQC in the case of online authorization and the authentication response is received from the transaction processor, such that the response data includes a response code of an issuer of the payment card indicating either acceptance or rejection of a financial transaction associated with the PIN entry request.

8. The system of claim 1, wherein the authentication request further includes the steps of: including transactional information of a financial transaction and question information in the authentication request along with the digit subset information based on the digit subset, such that the authentication request is sent to a transaction processor over a communications network.

9. The method of claim 8, wherein the authentication request further includes the steps of: accessing by a card reader the code stored as card data in a physical memory of the payment card using the digit subset; obtaining a comparison result of a comparison between the code stored in the card data and the digit subset; and including the comparison result in the authentication request sent to the transaction processor.

10. The method of claim 8, wherein the authentication response is received from the transaction processor and the response data contains confirmation information for the financial transaction including a comparison result of a comparison between the digit subset information based on the digit subset and the code stored in a code database accessible by the transaction processor using the question information.

11. The method of claim 1, wherein the PIN entry request includes instructions detailing which digit or digits of the sequence is or are to be omitted from the digit subset.

12. The method of claim 11, wherein the authentication request further includes the step: including information on which digit or digits of the sequence is or are to be omitted from the digit subset.

13. The method of claim 1, wherein the PIN entry request includes instructions detailing which digit or digits of the sequence is or are to be included in the digit subset.

14. The method of claim 13, wherein the authentication request further includes the step: including information on which digit or digits of the sequence is or are to be included in the digit subset.

15. The method of claim 12, wherein the digits of the digit subset are in the same order as said digits are in the sequence.

16. The method of claim 1, wherein the number of digits of the code is at least six and the number of digits in the digit subset is at least two.

17. The method of claim 1, wherein the code is stored as card data in a physical memory of the payment card, such that the card data also includes which digit or digits of the sequence of digits was or were not included in the digits of the digit subset in a previous PIN entry request.

18. The method of claim 17 further including the step of querying the card data to determine which digit or digits of the sequence of digits was or were not included in the digits of the digit subset in the previous PIN entry request and generating the PIN entry request to identify a different digit subset to that of the digit subset of the previous PIN entry request.

19. The method of claim 1, wherein the code is stored in a code database accessible by a transaction processor, such that card data associated with the payment card is also stored in the code database and includes which digit or digits of the sequence of digits was or were not included in the digits of the digit subset in a previous PIN entry request.

20. The method of claim 19 further including the step of querying the code database to determine which digit or digits of the sequence of digits was or were not included in the digits of the digit subset in the previous PIN entry request and generating the PIN entry request to identify a different digit subset to that of the digit subset of the previous PIN entry request.

21. The method of claim 2, wherein the card reader is a component of a computer device selected from the group comprising: a point of sale (POS) terminal and an automated teller machine (ATM).

22. The method of claim 21, wherein the PIN entry request is displayed on a display component of the computer device and the digit subset is received by a keypad component of the computer device.

23. A system for authenticating a personal identification number (PIN) associated with a payment card of a cardholder, the PIN being a code having a sequence of digits, the system comprising:
a computer processor coupled to a physical memory, wherein the computer processor is programmed by instructions to coordinate the authenticating of the PIN by:
presenting a PIN entry request to the cardholder including identifying a digit subset of the code, such that the digits in the digit subset is at least one digit less than the digits of the code;
receiving the digit subset in response to the PIN entry request;
sending an authentication request based on the digit subset;
receiving an authentication response including response data; and
presenting a response to the cardholder based on the response data, the response including information representative of whether the PIN was successfully authenticated or not using the digit subset.

24. The system of claim 23, wherein the number of digits in the digit subset is less than the number of digits in the code.

25. The system of claim 23, wherein the PIN entry request is selected from a set of available questions.

26. The system of claim 23, wherein the selection is a random selection.

27. The system of claim 23 further comprising the instruction of detecting whether a plurality of the authentication responses result in PIN authentication failure being over a predefined failure threshold within a predefined period of time and limiting the operation of the number of subsequent PIN entry requests presented to one or more of the cardholders.

27. A non-transitory computer readable storage medium with an executable program application stored thereon, the program application for authenticating a personal identification number (PIN) associated with a payment card of a cardholder, the PIN being a code having a sequence of digits, wherein the program application is configured to instruct a computer processor to perform the following steps of:
presenting a PIN entry request to the cardholder including identifying a digit subset of the code, such that the digits in the digit subset is at least one digit more than the digits of the code;
receiving the digit subset in response to the PIN entry request;
sending an authentication request based on the digit subset;
receiving an authentication response including response data; and
presenting a response to the cardholder based on the response data, the response including information representative of whether the PIN was successfully authenticated or not using the digit subset.
